(19) United States
(12) Patent Application Publication
(10) Pub. No.: US 2026/0356358 A1
(43) Pub. Date: Nov. 12, 2026

(54) VEHICLE SPEED CONTROL

(71) Applicant: Ford Global Technologies, LLC, Dearborn, MI (US)

(72) Inventors: Keith Weston, Canton, MI (US); Brendan Francis Diamond, Naples, FL (US); Michael Alan McNees, Flat Rock, MI (US)

(73) Assignee: Ford Global Technologies, LLC, Dearborn, MI (US)

(21) Appl. No.: 19/200,752

(22) Filed: May 7, 2025

(51) Int. Cl. B60W 30/14; B60W 30/16

(52) U.S. Cl. CPC B60W 30/143; B60W 30/16; B60W 2420/403; B60W 2420/408; B60W 2520/10; B60W 2552/40; B60W 2554/4042; B60W 2554/802; B60W 2555/20; B60W 2556/40

(57) ABSTRACT

Based on data collected by a sensor in a host vehicle about respective forward vehicles, a cruise adjustment is triggered in the host vehicle, typically based on speed data and/or map data. The cruise adjustment is actuated in response to the trigger by actuating host vehicle lighting, steering, propulsion, and/or braking. The cruise adjustment may include adjusting a speed of the host vehicle based on the speed of the host vehicle relative to a speed of a second vehicle in a lane adjacent to a lane of travel of the host vehicle, actuating host vehicle lighting without at a same time actuating steering, propulsion, and/or braking, an adjustment based on a current weather condition, and/or an adjustment based on a current road friction.

### BACKGROUND

Ground vehicles such as automobiles often operate on roads with other vehicles. Various traffic conditions can affect operation of a vehicle. For example, on a road or highway with multiple lanes, vehicles in different lanes may travel at different speeds. A speed at which a vehicle is operated can be affected by speeds at which other vehicles in a same or different lane are operated.

### BRIEF DESCRIPTION OF THE DRAWINGS

FIG. 1 is a diagram of an example vehicle system.

FIG. 2 illustrates an example road on which travel an ego or host vehicle and other vehicles.

FIG. 3 is a diagram of an example process for operating a vehicle with speed control.

### DESCRIPTION

### Introduction

Described herein are techniques for

A system comprises a processor and a memory. The memory stores instructions executable by the processor, including instructions to, based on data collected by a sensor in a host vehicle about respective forward vehicles, trigger a cruise adjustment in the host vehicle; and actuate the cruise adjustment in response to the trigger by actuating host vehicle lighting, steering, propulsion, and/or braking.

The forward vehicles can be disposed in two or more lanes of a roadway on which the host vehicle and the forward vehicles are traveling.

Actuating the cruise adjustment can include adjusting a minimum distance between the host vehicle and an immediately preceding vehicle. The immediately preceding vehicle can be one of the forward vehicles. The minimum distance can be proportional to a preset following distance in the host vehicle and/or based on the data about the forward host vehicles. a speed of the host vehicle based on the speed of the host vehicle relative to a speed of a second vehicle in a lane adjacent to a lane of travel of the host vehicle. Actuating the cruise adjustment can include actuating host vehicle lighting without at a same time actuating steering, propulsion, and/or braking. Actuating the cruise adjustment can an adjustment based on a current weather condition, and/or an adjustment based on a current road friction.

The data can include acceleration data of the forward vehicles and/or lateral movement data. The sensor can include a plurality of sensors, and the plurality of sensors can include two or more sensor types, including a radar, a lidar, and/or a camera.

Triggering the cruise adjustment can include triggering the cruise adjustment based on speed data and/or map data.

A method comprises, based on data collected by a sensor in a host vehicle about respective forward vehicles, triggering a cruise adjustment in the host vehicle; and actuating the cruise adjustment in response to the trigger by actuating host vehicle lighting, steering, propulsion, and/or braking.

The forward vehicles can be disposed in two or more lanes of a roadway on which the host vehicle and the forward vehicles are traveling.

Actuating the cruise adjustment can include adjusting a minimum distance between the host vehicle and an immediately preceding vehicle. The immediately preceding vehicle can be one of the forward vehicles. The minimum distance can be proportional to a preset following distance in the host vehicle and/or based on the data about the forward host vehicles. a speed of the host vehicle based on the speed of the host vehicle relative to a speed of a second vehicle in a lane adjacent to a lane of travel of the host vehicle. Actuating the cruise adjustment can include actuating host vehicle lighting without at a same time actuating steering, propulsion, and/or braking. Actuating the cruise adjustment can an adjustment based on a current weather condition, and/or an adjustment based on a current road friction.

The data can include acceleration data of the forward vehicles and/or lateral movement data. The sensor can include a plurality of sensors, and the plurality of sensors can include two or more sensor types, including a radar, a lidar, and/or a camera.

Triggering the cruise adjustment can include triggering the cruise adjustment based on speed data and/or map data.

### Example System

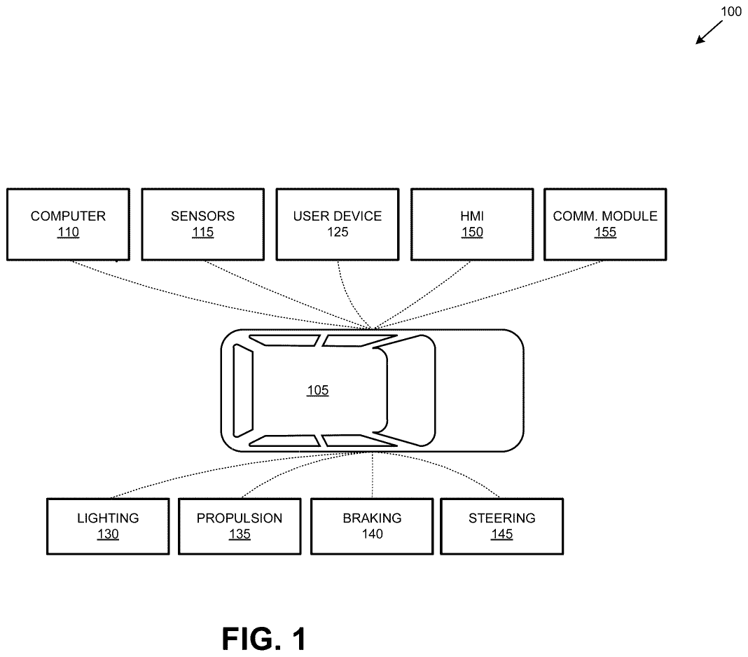

FIG. 1 illustrates an example system 100 for a vehicle 105. A computer 110 in the vehicle 105 is programmed to receive data collected from one or more sensors 115, and other sensors (not shown), to provide certain vehicle data. For example, one or more camera sensors 115 may provide image data from a camera's field of view. In another example, one or more radar sensors 115 can provide radar returns from objects such as other vehicles 106. A user device with a touch screen may be disposed in vehicle 105. Example user devices include a vehicle computer 110 communicatively coupled (e.g., via a vehicle network) to an HMI 150 with a touch screen installed as part of a vehicle 105 infotainment system, or a hand-held portable computing device 125 with a touch screen. While all modern original equipment manufacturers (OEMs) of passenger vehicles currently warn drivers against using a handheld portable device while driving a vehicle due to safety concerns, it is expected that technology and the regulatory framework may evolve in the future to where such an activity becomes safe and permissible.

Vehicle data may further include a location of the vehicle 105, data about an environment around a vehicle, data about an object outside the vehicle such as another vehicle, etc. A vehicle location may be provided in a conventional form such as by geo-coordinates such as latitude and longitude coordinates obtained via a navigation system that uses a global navigation satellite system (GNSS) such as the Global Positioning System (GPS) system. Further examples of vehicle data can include measurements of vehicle systems and components (e.g., a vehicle speed or velocity, a level of fuel in a fuel tank, an amount of available electric charge, etc.).

A computer 110 can be provided to control one or more vehicle operations including steering, acceleration, speed control, and/or braking. Accordingly, system 100 is shown comprising vehicle 105 which may include Driver Assistance System (DAS) features. A computer 110 (e.g., one or more vehicle 105 electronic control units, i.e., ECUs) can be configured to operate the vehicle 105 independently of operation by an occupant with regard to certain features. A computer 110 may be programmed to provide a driver assistance system (DAS) such as cruise control (where the computer maintains vehicle speed according to a set speed), adaptive cruise control (ACC) (where the computer maintains the vehicle speed according to a set speed but can adjust vehicle speed based on detected distances and/or speeds of other vehicles), and/or hands-free driving. For example, the computer 110 could provide hand-free driving in combination with ACC such that the computer 110 controls steering, braking and acceleration. In another example, the computer 110 could provide ACC and require hands-on operation. The computer 110 may be programmed to operate a lighting system 130, powertrain propulsion system 135, a braking system 140, a steering system 145, a device screen that displays a Human Machine Interface (HMI) 150, and/or other vehicle systems.

A computer 110 is generally programmed for communications on a vehicle network (not shown), for example, a conventional vehicle communications bus such as a Controller Area Network (CAN) bus, a Local Interconnect Network (LIN) bus, etc., and/or other wired and/or wireless technologies such as Bluetooth®, Wi-Fi®, Ethernet, etc. via the network, bus, and/or other wired or wireless mechanisms (e.g., a wired or wireless local area network in the vehicle 105), the computer 110 may transmit messages to various devices in the vehicle 105 and/or receive messages from the various devices such as sensors 115, controllers and actuators (not shown), etc.

Alternatively or additionally, for example, in cases where the computer 110 actually comprises multiple devices, the vehicle network may be used for communications between devices represented as the computer 110 in this disclosure. For example, the computer 110 can be a generic computer with a processor and memory as described above, and/or may include a dedicated electronic circuit including an application specific integrated circuit (ASIC) that is manufactured for a particular operation such as an ASIC for processing sensor data and/or communicating the sensor data. In another example, the computer 110 may include a Field-Programmable Gate Array (FPGA), which is an integrated circuit manufactured to be configurable by a user. Typically, a hardware description language such as Very high speed integrated circuit Hardware Description Language (VHDL) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming (e.g. stored in a memory electrically connected to the FPGA circuit). In some examples, a combination of processor(s), ASIC(s), and/or FPGA circuits may be included in computer 110.

In addition, the computer 110 may be programmed for communicating with a network and/or devices outside of the vehicle (not shown), which may include various wired and/or wireless networking technologies such as cellular, Bluetooth®, Bluetooth® Low Energy (BLE), wired and/or wireless packet networks, etc.

The memory can be of any type, for example hard disk drives, solid state drives, servers, or any volatile or non-volatile media. The memory can store the collected data sent from the sensors 115. The memory can be a separate device from the computer 110, and the computer 110 can retrieve data stored in the memory via a network in the vehicle 105, for example over a CAN bus, a wireless network, etc. Alternatively or additionally, the memory can be part of the computer 110 (e.g., as a memory of the computer 110).

Sensors 115 can include a variety of devices. For example, various controllers in a vehicle 105 may operate as sensors 115 to provide data via the vehicle network or bus such as data relating to vehicle speed, acceleration, location, subsystem and/or component status, etc. Further, other sensors 115 could include cameras, motion detectors, etc. (i.e., sensors 115 may provide data for evaluating a status of a component, evaluating a slope of a roadway, etc.). The sensors 115 could, without limitation, also include short range radar, long range radar, light detection and ranging (LIDAR), ultrasonic transducers, and the like. Cameras can include optical cameras (e.g., in the visible spectrum), and/or other kinds of cameras such as time-of-flight, infrared, etc.

In one example, the vehicle 105 includes one or more thermal camera sensors 115. Thermal cameras, one type being far-infrared cameras, can be used to detect animals in both low light and light-obscured conditions. Thermal cameras provide images in various lighting conditions (night, sun glare, etc.) and weather conditions (fog, rain, etc.) that can be superior to the contrast provided by cameras limited to the visible light region.

Collected data can include a variety of data collected in a vehicle 105. Examples of collected data are provided above. Data are generally collected using one or more sensors 115, and may additionally include data calculated therefrom in the computer 110. In general, collected data may include any data gathered by the sensors 115 and/or computed from such data.

The vehicle 105 can include a plurality of vehicle components. In this context, a vehicle component may include one or more hardware components adapted to perform a mechanical function or operation-such as moving the vehicle 105, slowing or stopping the vehicle 105, steering the vehicle 105, etc. Non-limiting examples of components include a lighting system 130 (e.g., that includes headlamps, taillamps, side lamps, and/or other vehicle lights or lamps) powertrain propulsion component 135 (that includes, e.g., an internal combustion engine and/or electric motor, etc.), a transmission component, a steering assembly (e.g., that may include one or more of a steering wheel, a steering rack, etc.), a brake component 140, a park assist component, an adaptive cruise control component, an adaptive steering component 145, a movable seat, and the like. Components can include computing devices such as electronic control units (ECUs) or the like and/or computing devices such as described above with respect to the computer 110, and that likewise communicate via a vehicle network.

The HMI 150 typically includes one or more of a display, a touchscreen display, a microphone, a speaker, etc. The user can provide input to devices such as the computer 110 via the HMI 150. The HMI 150 can communicate with the computer 110 via the vehicle network; for example, the HMI 150 can send a message including the user input provided via a touchscreen, microphone, a camera that captures a gesture, etc., to a computer 110, and/or can display output such as via a screen, speaker, etc.

In addition, the vehicle computer 110 may be configured for communicating via a vehicle-to-vehicle communication module 155 or interface with devices outside of the vehicle 105 (e.g., through a vehicle-to-vehicle (V2V) or vehicle-to-infrastructure (V2X) wireless communications (cellular and/or short-range radio communications, etc.) to another vehicle, and/or to a remote server computer (typically via direct radio frequency communications)). The communications module 155 could include one or more mechanisms, such as a transceiver, by which the computers of vehicles may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the communications module 155 include cellular, Bluetooth, IEEE 802.11, dedicated short range communications (DSRC), cellular V2X (CV2X), and/or wide area networks (WAN), including the Internet, providing data communication services. The label “V2X” is used herein for communications that may be vehicle-to-vehicle (V2V) and/or vehicle-to-infrastructure (V2I), and that may be provided by communication module 155 according to any suitable short-range communications mechanism (e.g., DSRC, cellular, or the like).

### Implementation Examples

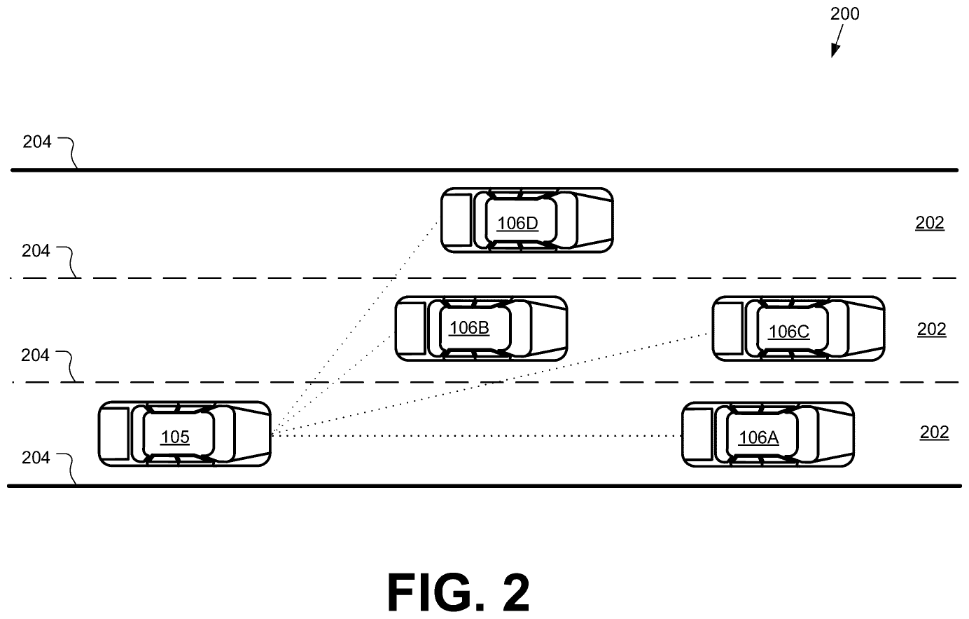

FIG. 2 illustrates an example road 200 with three lanes 202, on which travel an ego or host vehicle 105 and other vehicles 106A, 106B, 106C, 106D (referred to collectively as vehicles 106). In this example, vehicles 105, 106 in all three lanes 202 move in a same direction of travel. One or more sensors 115 in the host vehicle 105 can provide data including speed data about respective forward vehicles 106. For example, sensors 115 could be of one or more types (i.e., use one or more sensing media), such as radar, lidar, and/or a camera, etc. Based on data about vehicles 106, the computer 110 in the host vehicle 105 can trigger a cruise adjustment in the host vehicle. Thus, in the context of this disclosure, a “trigger” means a datum or data that causes the computer 110 to make a cruise adjustment (that is, as explained below, change vehicle 105 speed and/or direction).

The computer 110 can determine a respective speed datum or data for each of a plurality of vehicles 106 such as each vehicle 106A, 106B, 106C, 106D shown in FIG. 2 (an immediately preceding vehicle 106A is typically, but not necessarily, included in the forward vehicles 106 whose data is used to determine a trigger). The various vehicles 106 may be in a same or different lanes 202 of the roadway 200; speed data from a vehicle 106 can be an input to triggering a cruise adjustment. Typically, vehicles 106 whose data (typically including their respective speeds) is used as input to determine a trigger are vehicles 106 forward of the host vehicle 105 with respect to which vehicle 105 sensors 115 (e.g., radar, camera, etc.) have a line of sight or unobstructed view or access to the respective vehicle 106 to make a speed determination. Speed data for a vehicle 106 can include its speed based on radar sensor 115 data and/or camera sensor 115 data.

In addition to speed, data about a vehicle 106 can include a lane of travel and/or a distance from the vehicle 106, which can be taken as any suitable measure of distance between the vehicles 105, 106, such as a distance from a frontmost point on the vehicle 105 to a rearmost point on the vehicle 106. Further, data about a vehicle 106 can include image data, such as from an optical or infrared image sensor (or camera) 115. For example, image data could indicate that one or more vehicles 106 forward of the host vehicle 105 have activated brake lights. The computer 110 could be programmed to, upon determining that one or more forward vehicles 106 have activated brake lights, trigger a cruise adjustment in the vehicle 105. For example, the vehicle 105 speed could be reduced and/or a minimum distance to an immediately preceding vehicle 106 could be increased to accommodate a potential upcoming slowdown, or decreased to accommodate a reduction in host vehicle 105 speed.

The speed data to trigger the cruise adjustment can include data about forward vehicle(s) 106 movement(s) such as acceleration data of the forward vehicles 106. That is, speed data can include a vehicle 106 speed, that is, a rate of motion with respect to the ground, and/or can include derivatives thereof, such as acceleration (the first derivative of speed) or jerk (the second derivative of speed or the first derivative of acceleration). Further, the speed data can include longitudinal and/or lateral speed data. Further, speed data of vehicles 106 determined by the computer 110 can include some statistical measure of the speed data of the vehicles 106, such as an average, a range, etc. The speed data can include lateral speed data. For example, lateral movement and/or a lateral acceleration of a vehicle 106 might be a basis for a cruise adjustment, that is, if a vehicle 106 is moving laterally in a lane, as indicated by a lateral acceleration, a cruise adjustment such as slowing a host vehicle 105 or increasing a following distance to a forward vehicle 106A could be desirable. For example, a forward vehicle 106 with lateral acceleration above a threshold, or rapidly changing lateral accelerations, and/or one or more lane-changes, could indicate an aggressive driver (e.g., one “zipping” in and out of lanes 202), and could trigger a cruise adjustment, such as the host vehicle 105 reducing a speed and/or increasing a minimum distance to an immediately preceding vehicle 106. Further, in addition to, or as an alternative to, speed data, the cruise adjustment can be triggered by and/or based on map data, typically real-time or near real-time traffic data indicating speeds or an average speed of other vehicles 106, typically vehicles 106 forward of the host vehicle 105 on a roadway 200. For example, map data can provide an average speed of vehicles 105, 106 for a point or section of a roadway 200.

The cruise adjustment is an adjustment to a trajectory (i.e., a speed and/or heading) of a vehicle such as such as may be provided as part of a cruise control and/or hands-free driving system or some other advanced driver assistance system (ADAS). Typically, the cruise control or other ADAS includes an adaptive cruise control, that is, the vehicle 105 includes one or more radar sensors 115 and/or other sensors 115 to detect a distance between the vehicle 105 and another vehicle 106. The cruise adjustment can be an adjustment to a host vehicle 105 set speed and/or a following distance of the host vehicle 105 from a forward vehicle 106A in a same lane 202 as the host vehicle 105. For example, the cruise adjustment could include adjusting a minimum distance between the host vehicle 105 and an immediately preceding vehicle 106A (i.e., vehicle 106 forward of the host vehicle 105 in a same lane of the roadway 200, with no other vehicles 106 in between the vehicles 105, 106).

A minimum distance and/or a set (i.e., target) speed Sₕₒₛₜ of the host vehicle 105 can be based on a preset following distance D_{follow} in the host vehicle and/or based on the speed data about the forward host vehicles. For example, as shown in the tables below, a change of host vehicle 105 speed Sₕₒₛₜ could be actuated based on various triggers, such as an average speed S_{avg} of vehicles 106 on a roadway 200 being below a threshold speed Sₜₕᵣₑₛₕ, and a cruise adjustment could then include a set speed Sₕₒₛₜ for the host vehicle 105 that is based on (e.g., equal to) the average speed S_{avg} of the vehicles 106.

Further, the cruise adjustment could alternatively or additionally include determining a following distance D_{follow} for the host vehicle 105 to follow an immediately preceding vehicle 106 based on the average speed S_{avg} of the vehicles 106 or some other speed metric as described below. The distance D_{follow} can be proportional to the host vehicle set speed, e.g., the distance is typically less at lower speeds and greater at greater speeds. The proportionality, e.g., a multiplier from a default following distance for respective host vehicle set speeds could be determined empirically and/or by simulation. That is, empirical testing and/or simulation could be executed to determine a proportion of the default following distance suitable for various host vehicle 105 set speeds Sₕₒₛₜ. The distance D_{follow} could alternatively or additionally be adjusted for a coefficient of friction of a roadway 200. A current coefficient of friction could be available to the computer 110 via a vehicle 105 network, and the computer 110 could be programmed to adjust the set speed Sₕₒₛₜ for the host vehicle based on road friction. For example, a lookup table or the like could provide adjustment factors (e.g., a negative multiplier) developed empirically and/or via simulation for respective road friction coefficients or ranges thereof that could be applied to set a minimum distance or host vehicle 105 set speed Sₕₒₛₜ.

Alternatively or additionally, a cruise adjustment could include adjusting a speed of the host vehicle based on the speed of the host vehicle relative to a speed of a second vehicle in a lane adjacent to a lane of travel of the host vehicle. For example, if a speed of the host vehicle 105 is significantly greater (for example, 20 mph or more greater), an occupant of the host vehicle 105 and/or an occupant of another vehicle 106 could experience discomfort when the vehicles 105, 106 passed each other in adjacent lanes. Accordingly, a host vehicle 105 set speed Sₕₒₛₜ could be limited or set so as to not exceed a speed S_{avg_adj_lane} of vehicles 106 in an adjacent lane by more than a threshold ΔS_{thresh_adj}.

The computer 110 can typically cause actuation of the cruise adjustment (i.e., adjusting vehicle 105 speed) in response to the trigger by actuating host vehicle 105 propulsion 135 and/or braking 145. Further, the computer 110 could alternatively or additionally cause actuation of the cruise adjustment in response to the trigger by actuating host vehicle 105 lighting and/or steering. For example, the computer 110 could actuate a lane change ADAS in response to a trigger, which typically would include actuating propulsion 135 and/or braking 140 in addition to steering 145. Yet further for example, the computer 110 could actuate one or more lights on a host vehicle 105, either in conjunction with a change of vehicle 105 speed, such as a braking action, or without actuating braking 140 or propulsion 135, that is, lighting 130 could be actuated to signal other vehicles 106 with or without actuating propulsion 135, braking 140, and/or steering 145.

Actuation of the cruise adjustment could be implemented in a manner to enhance occupant comfort. For example, the computer 110 could be programmed to implement a cruise adjustment with a maximum negative acceleration (i.e., deceleration) and/or to avoid exceeding a specified rate of deceleration (i.e., jerk). For example, if a cruise adjustment includes adjusting a vehicle 105 speed to a reduced target speed Sₕₒₛₜ, the computer 110 could control actuation of propulsion 135 and/or braking 140 in a manner to avoid negative acceleration and/or jerk that exceed a predetermined threshold(s). “Avoid” in this context means that the threshold(s) will not be exceeded unless overridden by some other programming in the computer 110 (or some other vehicle 105 computer). For example, negative acceleration and/or jerk threshold negative acceleration and/or jerk threshold could be overridden by a minimum distance specified for the vehicle 105 to maintain from other vehicles 106. Negative acceleration and/or jerk thresholds could be developed empirically, that is, by an occupant or occupants in a test vehicle or vehicles 105 reporting comfortable accelerations and/or jerks.

As illustrated in FIG. 2 forward vehicles 106 can be disposed in two or more lanes 202 of a roadway 200 on which the host vehicle 105 and the forward vehicles 106 are traveling. As an input to determining a trigger, the host vehicle computer 110 may use respective speeds of the forward vehicles. Accordingly, the computer 110 determines the respective speeds of the forward vehicles 106, typically via data from sensors 115. Therefore, as represented by the dotted lines in FIG. 2, drawn from the host vehicle 105 to the respective vehicles 106, the sensors 115 (e.g., radar) rely on having lines of sight to the respective vehicles 106. Alternatively or additionally, the computer 110 could receive information about a speed and/or trajectory of a vehicle 106 via the communication module 155, that is, from the vehicle 106 or a cloud server or infrastructure element or the like. The cruise adjustment could include an adjustment based on a current weather condition. Yet further alternatively or additionally, as mentioned above, the cruise adjustment includes an adjustment based on a current road friction.

Table 1 below lists example data values that could be evaluated to determine a trigger:

| Data Value | Explanation |
|---|---|
| S_{avg} | Average speed of vehicles 106 (e.g., could be determined by vehicle |
| | sensors 115 and/or from real-time traffic data from a cloud server or |
| | the like). |
| S_{avg} − Sₕₒₛₜ | Difference between speed of host vehicle 105 and average speed of |
| | two or more forward vehicles 106 (typically regardless of whether in a |
| | same or different lane 202 than the host vehicle 105). May further be |
| | dependent on a distance D_{host, forward} between the host vehicle 105 and |
| | an immediately preceding vehicle 106 (i.e., empirical testing or |
| | simulation could establish different values of S_{avg} − Sₕₒₛₜ that would |
| | trigger a cruise adjustment based on different respective distances |
| | D_{host, forward}. |
| S_{avg}_{_{—}}_{adj}_{_{—}}ₗₐₙₑ − | Difference between speed of host vehicle 105 and average speed of |
| Sₕₒₛₜ | two or more vehicles 106 in a different (typically an adjacent) lane 202 |
| | than the host vehicle 105 (and typically regardless of whether forward |
| | of the host vehicle 105). May further be dependent on the distance |
| | D_{host, forward}. |

Table 2 below provides examples of triggers:

| Trigger | Explanation |
|---|---|
| S_{avg} < Sₜₕᵣₑₛₕ | Average speed of vehicles 106 less than a speed threshold Sₜₕᵣₑₛₕ |
| | for a roadway 200 (e.g., could be 15 KPH or some other speed |
| | established by empirical testing and/or simulation). |
| S_{avg} − Sₕₒₛₜ < | Difference S_{avg} − Sₕₒₛₜ is less than ΔSₜₕᵣₑₛₕ. |
| ΔSₜₕᵣₑₛₕ | |
| S_{avg} − Sₕₒₛₜ < | Difference S_{avg} − Sₕₒₛₜ is less than ΔSₜₕᵣₑₛₕ, and D_{host, forward} < Dₜₕᵣₑₛₕ |
| ΔSₜₕᵣₑₛₕ AND | where Dₜₕᵣₑₛₕ could be determined for the current difference S_{avg} − |
| D_{host, forward} < | Sₕₒₛₜ (e.g., from a lookup table or the like stored by the computer |
| Dₜₕᵣₑₛₕ for S_{avg} − | 110). |
| Sₕₒₛₜ | |
| S_{avg}_{_{—}}_{adj}_{_{—}}ₗₐₙₑ − | Difference S_{avg}_{_{—}}_{adj}_{_{—}}ₗₐₙₑ − Sₕₒₛₜ is less than ΔSₜₕᵣₑₛₕ_{_{—}}_{adj}, where |
| Sₕₒₛₜ < | ΔSₜₕᵣₑₛₕ_{_{—}}_{adj} could be determined form empirical testing or simulation |
| ΔSₜₕᵣₑₛₕ_{_{—}}_{adj} | and could be stored in a lookup table or the like of the computer |
| | 110. |
| S_{avg}_{_{—}}_{adj}_{_{—}}ₗₐₙₑ − | Difference S_{avg}_{_{—}}_{adj}_{_{—}}ₗₐₙₑ − Sₕₒₛₜ is less than ΔSₜₕᵣₑₛₕ_{_{—}}_{adj}, where |
| Sₕₒₛₜ < | ΔSₜₕᵣₑₛₕ_{_{—}}_{adj} could be determined form empirical testing or simulation |
| ΔSₜₕᵣₑₛₕ_{_{—}}_{adj} AND | and could be stored in a lookup table or the like of the computer |
| D_{host, forward} < | 110, and Dₜₕᵣₑₛₕ could be determined for the current difference S_{avg} − |
| Dₜₕᵣₑₛₕ for S_{avg} − | Sₕₒₛₜ (e.g., from a lookup table or the like stored by the computer |
| Sₕₒₛₜ (or, | 110). |
| alternatively, for | |
| ΔSₜₕᵣₑₛₕ_{_{—}}_{adj}) | |

Table 3 below provides examples of cruise adjustments based on various triggers:

| Trigger | Cruise adjustment |
|---|---|
| S_{avg} < Sₜₕᵣₑₛₕ | Reduce vehicle 105 speed Sₕₒₛₜ (e.g., to S_{avg}) and or adjust a |
| | following distance D_{follow} to an immediately preceding vehicle 106, |
| | e.g., as specified in a lookup table or the like (that could be |
| | developed empirically and/or by simulation). |
| S_{avg} − Sₕₒₛₜ < | Reduce vehicle 105 speed (e.g., to S_{avg}). |
| ΔSₜₕᵣₑₛₕ | |
| S_{avg} − Sₕₒₛₜ < | Reduce vehicle 105 speed (e.g., to S_{avg}). |
| ΔSₜₕᵣₑₛₕ AND | |
| D_{host, forward} < | |
| Dₜₕᵣₑₛₕ for S_{avg} − | |
| Sₕₒₛₜ | |
| S_{avg}_{_{—}}_{adj}_{_{—}}ₗₐₙₑ − | Reduce vehicle 105 speed (e.g., to S_{avg}_{_{—}}_{adj}_{_{—}}ₗₐₙₑ or to S_{avg}_{_{—}}_{adj}_{_{—}}ₗₐₙₑ + |
| Sₕₒₛₜ < | ΔS, where ΔS has been established empirically or by simulation to |
| ΔSₜₕᵣₑₛₕ_{_{—}}_{adj} | be a speed difference acceptable for the host vehicle 105 in a first |
| | lane 202 compare to the speed S_{avg}_{_{—}}_{adj}_{_{—}}ₗₐₙₑ of vehicles 106 in an |
| | adjacent lane 202; ΔS could be stored in a lookup table or the like |
| | for different speeds or ranges of speed S_{avg}_{_{—}}_{adj}_{_{—}}ₗₐₙₑ or values |
| | S_{avg}_{_{—}}_{adj}_{_{—}}ₗₐₙₑ − Sₕₒₛₜ). |
| S_{avg}_{_{—}}_{adj}_{_{—}}ₗₐₙₑ − | Reduce vehicle 105 speed (e.g., to S_{avg}_{_{—}}_{adj}_{_{—}}ₗₐₙₑ or to S_{avg}_{_{—}}_{adj}_{_{—}}ₗₐₙₑ + |
| Sₕₒₛₜ < | ΔS and/or set D_{follow} to distance from lookup table or the like. |
| ΔSₜₕᵣₑₛₕ_{_{—}}_{adj} AND | |
| D_{host, forward} < | |
| Dₜₕᵣₑₛₕ for S_{avg} − | |
| Sₕₒₛₜ (or, | |
| alternatively, for | |
| ΔSₜₕᵣₑₛₕ_{_{—}}_{adj}) | |

The foregoing tables are provided as non-limiting examples. It is to be understood that the vehicle 105 could trigger other suitable and/or conventional cruise adjustments. For example, a conventional adaptive cruise control may adjust a host vehicle 105 speed based on a changing distance and/or relative speed with respect to an immediately preceding forward vehicle 106.

### Example Process

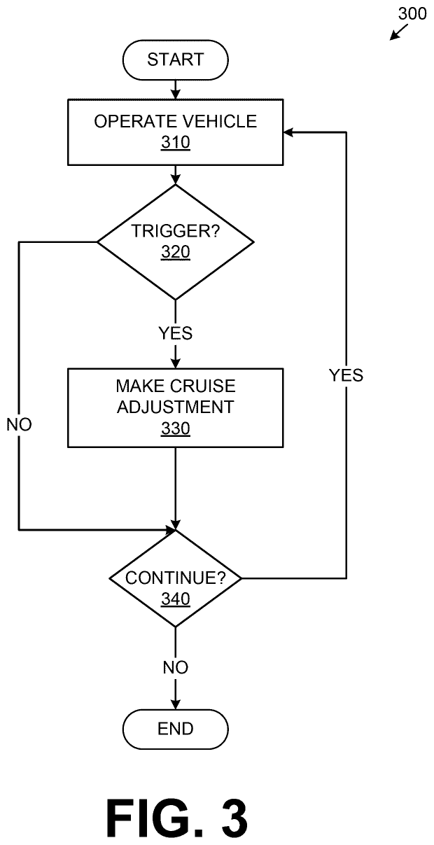

FIG. 3 is a diagram of an example process 300 for operating a vehicle 105 with speed control. The process 300 can be carried out according to instructions stored in a memory, and executed by a processor, of a vehicle computer 110.

The process 300 begins in a block 310, in which a vehicle 105 is operated on a road 200 having lanes 202, where the vehicle 105 is traveling in one of the lanes 202 and typically other vehicles 106 are travelling in the lanes 202 in a same direction as the host vehicle 105, such as illustrated in FIG. 2. During operation, the computer 110 can receive data from vehicle sensors 115 providing data about speeds of other vehicles 106 and/or their distances from the host vehicle 105. The computer 110 as noted above can additionally or alternatively obtain data about one or more vehicles 106 from other sources, such as a cloud server or the like that provides traffic data including a speed or speeds (e.g., an average speed) of vehicles 106 on a road 200 and or in a lane or respective lanes 202 of the road 200.

Next, in a block 320, the computer 110 determines whether to trigger a cruise adjustment, for example according to a trigger such as described above. If yes, then the process 300 proceeds to a block 330; if a trigger is not determined, the process 300 proceeds to a block 340.

In the block 330, the computer 110 actuates (or sends instructions or commands to other computers, ECUs, etc., in the vehicle 105 to actuate) one or more vehicle components with implement the cruise adjustment triggered in the block 320. For example, propulsion 135 and/or braking could be actuated to adjust a vehicle 105 speed. Alternatively or additionally, lighting 130 could be actuated (e.g., taillights could be activated to inform following vehicles 106 of a possible slowdown). Further alternatively or additionally, HMI 150 could be actuated to inform a vehicle 105 occupant (e.g., via a display, haptic output, etc.) of a possible slowdown in road 200 traffic and/or a change in vehicle 105 speed.

In the block 340, which may follow one of the blocks 320, 330, it is determined whether the process 300 should continue. For example, an operator could deactivate a cruise control ADAS, a vehicle 105 could be powered down or could stop, etc. If the process 300 is to continue, the process returns to the block 305. Otherwise, the process 300 ends following the block 340.

### CONCLUDING REMARKS

Systems and methods described herein may be modified and/or omitted depending on the context, situation, and applicable laws, rules, and regulations. Further, regardless of actions that may be taken by a vehicle such as a computer controlling a vehicle, users should use good judgement and common sense when operating the vehicle. Operations described herein should always be implemented and/or performed in accordance with the owner manual and safety guidelines.

The computing devices discussed herein, including computer 110, include processors and memories. The memories generally including instructions executable by one or more of the computing devices' processors, such as instructions disclosed in the foregoing, and instructions for carrying out blocks or steps of processes described above. Computer executable instructions may be compiled or interpreted from computer programs created using a variety of programming languages and/or technologies, including, without limitation, and either alone or in combination, Java™, C, C++, Visual Basic, Java Script, Python, Perl, HTML, etc. In general, a processor (e.g., a microprocessor) receives instructions (e.g., from a memory, a computer readable medium, etc.), and executes these instructions, thereby causing one or more actions and/or processes to occur, including one or more of the processes described herein. Such instructions and other data may be stored and transmitted using a variety of computer readable media. A file in the computer 110 is generally a collection of data stored on a computer readable medium, such as a storage medium, a random access memory, etc.

A computer readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

With regard to the media, processes, systems, methods, etc., described herein, it should be understood that, although the steps of such processes, etc., have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in above description of processing, one or more of the steps could be omitted, or the steps could be executed in a different order than shown and described. In other words, the descriptions of systems and/or processes herein are provided for the purpose of illustrating certain embodiments and should in no way be construed so as to limit the disclosed subject matter.

“Based on” means based at least in part on unless explicitly stated otherwise. That is, the phrase “based on” encompasses being partly or entirely based on. Therefore, if A is “based on” B, this means that A could be entirely determined based on B, or could be determined based on B and some other factor or factors.

Accordingly, it is to be understood that the present disclosure, including the above description and the accompanying Figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The article “a” modifying a noun should be understood as meaning one or more unless stated otherwise, or context requires otherwise.

1. A system, comprising a processor and a memory, the memory storing instructions executable by the processor, including instructions to:
based on data collected by a sensor in a host vehicle about respective forward vehicles, trigger a cruise adjustment in the host vehicle; and
actuate the cruise adjustment in response to the trigger by actuating host vehicle lighting, steering, propulsion, and/or braking.

2. The system of claim 1, wherein the forward vehicles are disposed in two or more lanes of a roadway on which the host vehicle and the forward vehicles are traveling.

3. The system of claim 1, wherein the instructions to actuate the cruise adjustment include instructions to adjust a minimum distance between the host vehicle and an immediately preceding vehicle.

4. The system of claim 3, wherein the immediately preceding vehicle is one of the forward vehicles.

5. The system of claim 3, wherein the minimum distance is proportional to a preset following distance in the host vehicle and/or based on the data about the forward host vehicles.

6. The system of claim 1, wherein the instructions to actuate the cruise adjustment include instructions to adjust a speed of the host vehicle based on the speed of the host vehicle relative to a speed of a second vehicle in a lane adjacent to a lane of travel of the host vehicle.

7. The system of claim 1, wherein actuating the cruise adjustment includes actuating host vehicle lighting without at a same time actuating steering, propulsion, and/or braking.

8. The system of claim 1, wherein the data include acceleration data of the forward vehicles.

9. The system of claim 1, wherein the data include lateral movement data.

10. The system of claim 1, wherein the sensor is a plurality of sensors, and the plurality of sensors includes two or more sensor types, including a radar, a lidar, and/or a camera.

11. The system of claim 1, wherein the cruise adjustment includes an adjustment based on a current weather condition.

12. The system of claim 1, wherein the cruise adjustment includes an adjustment based on a current road friction.

13. The system of claim 1, wherein the instructions to trigger the cruise adjustment include instructions to trigger the cruise adjustment based on speed data and/or map data.

14. A method, comprising:
based on data collected by a sensor in a host vehicle about respective forward vehicles, triggering a cruise adjustment in the host vehicle; and
actuating the cruise adjustment in response to the trigger by actuating host vehicle lighting, steering, propulsion, and/or braking.

15. The method of claim 14, wherein the forward vehicles are disposed in two or more lanes of a roadway on which the host vehicle and the forward vehicles are traveling.

16. The method of claim 14, wherein actuating the cruise adjustment includes:
adjusting a minimum distance between the host vehicle and an immediately preceding vehicle,
adjusting a speed of the host vehicle based on the speed of the host vehicle relative to a speed of a second vehicle in a lane adjacent to a lane of travel of the host vehicle,
actuating host vehicle lighting without at a same time actuating steering, propulsion, and/or braking,
an adjustment based on a current weather condition, and/or
an adjustment based on a current road friction.

17. The method of claim 16, wherein the immediately preceding vehicle is one of the forward vehicles.

18. The method of claim 14, wherein the data include acceleration data of the forward vehicles and/or lateral movement data.

19. The method of claim 14, wherein the sensor is a plurality of sensors, and the plurality of sensors includes two or more sensor types, including a radar, a lidar, and/or a camera.

20. The method of claim 14, wherein triggering the cruise adjustment includes triggering the cruise adjustment based on speed data and/or map data.
